(19) United States
(12) Patent Application Publication
(10) Pub. No.: US 2025/0150528 A1
(43) Pub. Date: May 8, 2025

(54) MANAGING ALWAYS-ON-DISPLAY OF AN ELECTRONIC DEVICE

(71) Applicant: SAMSUNG ELECTRONICS CO., LTD., Suwon-si (KR)

(72) Inventors: Sumit KUMAR, Bengaluru (IN); Harichandana Bhogaraju Swarajya Sai, Bengaluru (IN); Deepak Chaurasia, Bengaluru (IN)

(73) Assignee: SAMSUNG ELECTRONICS CO., LTD., Suwon-si (KR)

(21) Appl. No.: 19/018,662

(22) Filed: Jan. 13, 2025

Related U.S. Application Data
(63) Continuation of application No. PCT/IB2024/058674, filed on Sep. 6, 2024.

(30) Foreign Application Priority Data
Sep. 6, 2023 (IN) 202341059986

(51) Int. Cl. H04M 1/72454; G06F 1/3234

(52) U.S. Cl. CPC H04M 1/72454; G06F 1/3265

(57) ABSTRACT

A method for managing an Always-on-Display (AoD) of an electronic device, includes: receiving a candidate AoD content to be displayed on the electronic device and a AoD contextual information; determining an AoD preferred pattern of a user of the electronic device based on the candidate AoD content and the AoD contextual information; generating a set of variable AoD content corresponding to the candidate AoD content based on the AoD preferred pattern of the user and the AoD contextual information, wherein AoD content of the set of variable AoD content is generated for changes in the AoD contextual information; and displaying the set of variable AoD content on the electronic device.

### CROSS-REFERENCE TO RELATED APPLICATIONS

This application is a by-pass continuation application of International Application No. PCT/IB2024/058674, filed on Sep. 6, 2024, which is based on and claims priority to Indian Patent Application No. 202341059986 (Provisional Specification), filed in the Indian Patent Office on Sep. 6, 2023, and Indian Patent Application No. 202341059986 (Complete Specification), filed in the Indian Patent Office on Aug. 13, 2024, the disclosures of which are incorporated by reference herein in their entireties.

### 1. FIELD

The disclosure relates to electronic devices, and in particular, to managing an Always-on-Display (AoD) of an electronic device.

### 2. DESCRIPTION OF RELATED ART

The mobile device and wearable technology industries are experiencing significant growth, driven by the increasing popularity and widespread adoption of these devices. A component of these devices is the display, which necessitates continuous innovation to enhance the user experience. One such innovation is the AoD feature, which has gained significant traction among consumers. Statistics show that people frequently check their mobile phones or smartwatches to view information such as time, battery level, and message reminders. This has led to the emergence of the AoD function, wherein only some pixels on the screen are illuminated to display information. The AoD feature leverages the capability of Organic Light-Emitting Diode (OLED) and Active-Matrix Organic Light-Emitting Diode (AMOLED) displays to selectively illuminate individual pixels. This selective illumination enables the display of information such as time, date, and notifications without fully activating the screen, thereby conserving energy and providing convenience. This feature may be used in smartwatches, where without the AoD, the device may not function like other types of watches.

Early AoD implementations were limited to black-and-white displays with a simple design. However, advancements in technology have enabled color AoD displays, offering users a wider range of display options. Current features can even integrate AoD content with system wallpapers to create visual effects when unlocking the device. Consequently, the demand for improved and customizable AoD features continues to grow, driving innovation in display technology and user interface design.

Despite these advancements, issues persist with existing AoD implementations. Activation of the AoD feature may increase power consumption, causing the battery to drain more quickly. Additionally, AoD consistency may not be provided across multiple devices. Furthermore, existing methods for implementing a fixed AoD may negatively affect user experience and device longevity, as lower battery levels may necessitate better optimizations. Consequently, there is a need for a dynamic and adaptive AoD that may consider user and device context, that may enhance user personalization, and that may provide consistency across interconnected devices.

### SUMMARY

According to an aspect of the disclosure, a method for managing an Always-on-Display (AoD) of an electronic device, includes: receiving a candidate AoD content to be displayed on the electronic device and a AoD contextual information; determining an AoD preferred pattern of a user of the electronic device based on the candidate AoD content and the AoD contextual information; generating a set of variable AoD content corresponding to the candidate AoD content based on the AoD preferred pattern of the user and the AoD contextual information, wherein a plurality of AoD content of the set of variable AoD content is generated for a plurality of changes in the AoD contextual information; and displaying the set of variable AoD content on the electronic device.

The method may further include: determining at least one variable AoD content from the set of variable AoD content based on a plurality of aesthetic parameters including at least one from among color schemes, font styles, and layout configurations, wherein the plurality of aesthetic parameters are dynamically adjusted based on ambient light conditions and user activity patterns; and displaying the at least one variable AoD content on the AoD of the electronic device.

The method may further include: determining at least one cross-device AoD content from the set of variable AoD content based on the AoD contextual information, wherein the at least one cross-device AoD content is consistent across a plurality of devices of the user; and displaying the at least one cross-device AoD content on the AoD of the electronic device.

The receiving the candidate AoD content and the AoD contextual information may include: determining user context information based on a plurality of user parameters including at least one from among a behavior of the user, an emotional state of the user, a user preferences, an user personality, and a user defined AoD pattern; determining device context information based on a plurality of device parameters including at least one from among a screen configuration, a battery information, temperature, location, time, and a user event; and determining, by the electronic device, the AoD contextual information based on the user context information and the device context information, wherein the AoD contextual information indicates external context information of the electronic device and internal context information of the electronic device.

The emotional state may be determined based on at least one of one or more biometric sensor inputs or content of one or more user interactions.

The method may further include: determining an effect weightage for a plurality of AoD preferred patterns based on the AoD contextual information; and storing the effect weightage for the plurality of AoD preferred patterns.

The determining the AoD preferred pattern may include: segmenting the candidate AoD content into a plurality of segments; generating modified candidate AoD content including one or more salient segments of the candidate AoD content by extracting the one or more salient segments from the plurality of segments based on the AoD contextual information; determining one or more semantic features from the candidate AoD content and the modified candidate AoD content; and determining the AoD preferred pattern based on the one or more semantic features and the AoD contextual information.

The generating the set of variable AoD content and the AoD contextual information may include: determining at least one AoD content creation method from among a plurality of AoD content creation methods based on a type of the candidate AoD content and the AoD contextual information; prioritizing the at least one AoD content creation method over remaining AoD content creation methods of the plurality of AoD content creation methods based on the type of the candidate AoD content and the AoD contextual information; and generating the set of variable AoD content by applying the at least one prioritized AoD content creation method based on the AoD preferred pattern and the AoD contextual information.

The plurality of AoD content creation methods may include weighted binarization, adaptive points, a diffusion-based model, and adaptive brightness.

The type of the candidate AoD content may include one from among text, audio, an image, an animation, a video, a Graphics Interchange Format (GIF) file, and interactive content.

According to an aspect of the disclosure, an electronic device for managing an Always-on-Display (AoD), includes: memory storing instructions; a communication processor; and an AoD controller communicatively coupled to the memory and the communication processor, wherein the communication processor may be configured to execute the instructions to cause the AoD controller to: receive a candidate AoD content to be displayed on the electronic device and a AoD contextual information; determine an AoD preferred pattern of a user of the electronic device based on the candidate AoD content and the AoD contextual information; generate a set of variable AoD content corresponding to the candidate AoD content based on the AoD preferred pattern of the user and the AoD contextual information, wherein a plurality of AoD content of the set of variable AoD content is generated for a plurality of changes in the AoD contextual information; and display the set of variable AoD content on the electronic device.

The communication processor may be configured to execute the instructions to cause the AoD controller to: determine at least one variable AoD content from the set of variable AoD content based on a plurality of aesthetic parameters including at least one from among color schemes, font styles, and layout configurations, wherein the plurality of aesthetic parameters are dynamically adjusted based on ambient light conditions and user activity patterns; and display the at least one variable AoD content on the AoD of the electronic device.

The communication processor may be configured to execute the instructions to cause the AoD controller to: determine at least one cross-device AoD content from the set of variable AoD content based on the AoD contextual information, wherein the at least one cross-device AoD content is consistent across a plurality of devices of the user; and display the at least one cross-device AoD content on the AoD of the electronic device.

The communication processor may be configured to execute the instructions to cause the AoD to: determine user context information based on a plurality of user parameters including at least one from among a behavior of the user, an emotional state of the user, a user preferences, an user personality, and a user defined AoD pattern; determine device context information based on a plurality of device parameters including at least one from among a screen configuration, a battery information, temperature, location, time, and a user event of the electronic device; and determine the AoD contextual information based on the user context information and the device context information, wherein the AoD contextual information indicates external context information of the electronic device and internal context information of the electronic device.

The the emotional state may be determined based on at least one of one or more biometric sensor inputs or content of one or more user interactions.

The communication processor may be configured to execute the instructions to cause the AoD controller to: determine an effect weightage for a plurality of AoD preferred patterns based on the AoD contextual information; and store the effect weightage for the plurality of AoD preferred patterns.

The communication processor may be configured to execute the instructions to cause the AoD controller to: segment the candidate AoD content into a plurality of segments; generate modified candidate AoD content including one or more salient segments of the candidate AoD content by extracting the one or more salient segments from the plurality of segments based on the AoD contextual information; determine one or more semantic features from the candidate AoD content and the modified candidate AoD content including the one or more salient segments of the candidate AoD content; and determine the AoD preferred pattern based on the one or more semantic features and the AoD contextual information.

The communication processor may be configured to execute the instructions to cause the AoD controller to: determine at least one AoD content creation method from among a plurality of AoD content creation methods based on a type of the candidate AoD content and the AoD contextual information; prioritize the at least one AoD content creation method over remaining AoD content creation methods of the plurality of AoD content creation methods based on the type of the candidate AoD content and the AoD contextual information; and generate the set of variable AoD content by applying the at least one prioritized AoD content creation method based on the AoD preferred pattern and the AoD contextual information.

The plurality of AoD content creation methods may include weighted binarization, adaptive points, a diffusion-based model, and adaptive brightness.

According to an aspect of the disclosure, a non-transitory computer-readable recording medium having instructions recorded thereon, that, when executed by a communication processor communicatively coupled to an AoD controller of an Always-on-Display (AoD) of an electronic device, cause the AoD controller to: receive a candidate AoD content to be displayed on the electronic device and a AoD contextual information; determine an AoD preferred pattern of a user of the electronic device based on the candidate AoD content and the AoD contextual information; generate a set of variable AoD content corresponding to the candidate AoD content based on the AoD preferred pattern of the user and the AoD contextual information, wherein a plurality of AoD content of the set of variable AoD content is generated for a plurality of changes in the AoD contextual information; and display the set of variable AoD content on the electronic device.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a schematic diagram that illustrates managing AoD of the electronic device;

FIG. 2 is a block diagram of an electronic device for managing the AoD according to one or more embodiments;

FIG. 3 is a block diagram that illustrates an architecture of an AoD controller for managing the AoD of the electronic device according to one or more embodiments;

FIG. 4A is a schematic diagram that illustrates a method of context interpretation and representation for managing the AoD of the electronic device according to one or more embodiments;

FIG. 4B is a schematic diagram that illustrates a contextual information extractor of context interpretation and representation block according to one or more embodiments;

FIG. 4C is a schematic diagram that illustrates a contextual encoder of the context interpretation and representation block according to one or more embodiments;

FIG. 5 is a schematic diagram that illustrates an AoD content pre-processing block for managing the AoD of the electronic device according to one or more embodiments;

FIG. 6A is a schematic diagram that illustrates an AoD content understanding block for managing the AoD of the electronic device according to one or more embodiments;

FIG. 6B is a schematic diagram that illustrates a method of base inventory creation for the AoD content understanding according to one or more embodiments;

FIG. 6C is a schematic diagram that illustrates a content relevancy check module for the AoD content understanding according to one or more embodiments;

FIG. 6D is a schematic diagram that illustrates a pattern finalizer for the AoD content understanding according to one or more embodiments;

FIG. 7A is a schematic diagram that illustrates a method of generating a set of variable AoD contents for managing the AoD of the electronic device according to one or more embodiments;

FIG. 7B is a schematic diagram that illustrates a method of generating the set of AoD content using a weighted binarization method according to one or more embodiments;

FIG. 7C is a graphical representation illustrating the effects of employing the weighted binarization for the AoD content creation on the battery life of the electronic device according to one or more embodiments;

FIG. 7D is a schematic diagram that illustrates a method of generating the set of AoD content using an adaptive points method according to one or more embodiments;

FIG. 7E is a schematic diagram that illustrates a method of generating the set of AoD content using a diffusion network method according to one or more embodiments;

FIG. 8 is a schematic diagram that illustrates a method of AoD content validation for managing the AoD of the electronic device according to one or more embodiments;

FIG. 9A is a flow diagram that illustrates a method of generating consistent cross-device AoD content across multiple devices of the user according to one or more embodiments;

FIG. 9B illustrates an example of achieving the consistent cross-device AoD content across multiple devices of the user according to one or more embodiments;

FIG. 10A illustrates a use case of dynamic AoD customization of the electronic device according to one or more embodiments;

FIG. 10B illustrates a use case of dynamic AoD customization based on the internal context of the electronic device according to one or more embodiments;

FIG. 10C illustrates a use case of dynamic AoD customization based on the pixel ratio of the AoD content in the electronic device according to one or more embodiments;

FIG. 10D illustrates a use case of user perception-based AoD customization of the electronic device according to one or more embodiments;

FIG. 10E illustrates a use case of dynamic AoD customization based on the external context of the electronic device according to one or more embodiments;

FIG. 10F illustrates a use case of image features-based AoD customization of the electronic device according to one or more embodiments; and

FIG. 11 is a flow chart that illustrates a method for managing the AoD of the electronic device according to one or more embodiments.

### DETAILED DESCRIPTION

The embodiments described in the disclosure, and the configurations shown in the drawings, are only examples of embodiments, and various modifications may be made without departing from the scope and spirit of the disclosure.

The various embodiments described herein are not necessarily mutually exclusive, as some embodiments can be combined with one or more other embodiments to form new embodiments. The term “or” as used herein, refers to a non-exclusive or, unless otherwise indicated. The examples used herein are provided to facilitate an understanding of examples in which the one or more embodiments can be practiced and to enable those skilled in the art to practice the embodiments herein. However, the examples are not be construed as limiting the scope of the disclosure.

Various embodiments are described and illustrated in terms of blocks that carry out a described function or functions. These blocks, which referred to herein as managers, units, modules, hardware components or the like, may be implemented by analog and/or digital circuits such as logic gates, integrated circuits, microprocessors, microcontrollers, memory circuits, passive electronic components, active electronic components, optical components, hardwired circuits and the like, and may be driven by firmware and/or software. The circuits, for example, may be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the disclosure. Likewise, the blocks of the embodiments be physically combined into more complex blocks without departing from the scope of the disclosure.

The accompanying drawings are used to facilitate understanding of various technical features, and it is understood that the various embodiments presented herein are not limited by the accompanying drawings. As such, the disclosure extends to any alterations, equivalents and substitutes in addition to those which are set out in the accompanying drawings. Additionally, although the terms first, second, etc. used herein to describe various elements, these elements are not be limited by these terms. These terms are used to distinguish one element from another.

The present invention discloses a method for managing AoD of an electronic device. The method includes receiving, by the electronic device, a candidate AoD content to be displayed on the electronic device and AoD contextual information, and determining, by the electronic device, an AoD preferred pattern of a user of the electronic device based on the candidate AoD content and the AoD contextual information. Further, the method includes generating, by the electronic device, a set of variable AoD contents corresponding to the candidate AoD content based on the AoD preferred pattern of the user of the electronic device and the AoD contextual information, wherein each AoD content of the set of AoD contents is generated for changes in the AoD contextual information, and displaying, by the electronic device, the set of variable AoD contents on the electronic device.

An electronic device for managing AoD of the electronic device, according to one or more embodiments, is provided herein. The electronic device receives the candidate AoD content to be displayed on the electronic device and the AoD contextual information, and determines the AoD preferred pattern of the user of the electronic device based on the candidate AoD content and the AoD contextual information. Further, the electronic device generates the set of variable AoD contents corresponding to the candidate AoD content based on the AoD preferred pattern of the user of the electronic device and the AoD contextual information, wherein each AoD content of the set of AoD contents is generated for changes in the AoD contextual information, and displays, by the electronic device, the set of variable AoD contents on the electronic device.

Managing the AoD may involve adjusting the display interface primarily based on the power consumption of the electronic device. The AoD of the electronic device may change in response to an automatic change event corresponding to the current device context. For instance, lock screen wallpaper content may be displayed based on a currently playing podcast audio track or active application program or service. Some methods may consider the user's state (mood, emotional state, etc.) and device parameters (location, time) to select an appropriate display image or video. These methods may involve detecting objects in an image and modifying it with graphical effects or transitions (patterns) based on user and device parameters to generate a video clip. Additionally, some methods may utilize the user's chosen wallpaper to generate a custom AoD pattern by identifying a “region of interest” in the wallpaper. Based on this region, the device creates a unique AoD pattern displayed while the screen is off. Some methods may include retrieving weather data for a specific location at set intervals. Based on this data, the device determines the information to display, such as text, icons, or patterns, reflecting the current weather. The device then adjusts the display attributes, such as color and brightness of this chosen information for visibility on the AoD while minimizing power consumption.

One or more embodiments dynamically adapt the AoD based on device power consumption and other user and device contexts such as user preferences, image type, emotional state, and device location. This approach allows the AoD to be responsive and personalized to unique preferences of each user. For instance, the AoD may display calming images when the user is detected to be stressed, or it may show vibrant, energetic visuals when the user is in a positive emotional state. Additionally, the device location may influence the AoD content, such as displaying weather updates when the user is outdoors or showing calendar reminders when the user is at work. This dynamic adaptation may be used for remaining AoD content.

One or more embodiments may extract information from the AoD content received by the electronic device. One or more embodiments may include a validation framework to validate the generated AoD content. This validation framework may ensure the AoD content is relevant, accurate, aesthetically pleasing, and contextually appropriate. For example, if the AoD is set to display a motivational quote, the validation framework ensures that the quote is legible, appropriately sized, and harmoniously integrated with the background image. Furthermore, one or more embodiments may provide consistent cross-device AoD content across multiple devices of the user, thus enhancing user personalization and ensuring consistency across all interconnected devices. This means that whether the user is looking at their smartphone, tablet, or smartwatch, the AoD content will be seamlessly synchronized, providing a unified and cohesive experience.

One or more embodiments may provide a framework to generate dynamically adaptive and aesthetically pleasing AoD content using user contextual information (such as personality, emotional state, etc.) and device contextual information (such as screen shape and dimensions, battery state, etc.) with the added feature of customization to improve user experience and device life. The framework is used to display consistent and dynamic AoD content that adapts according to user and device contextual information. It consists of automatically determining the AoD pattern or effect based on the image and maintaining the aesthetic quality of the final AoD. The framework also used to maintain cross-device consistency for AoD content, wherein at least one cross-device AoD content is consistent across multiple devices of the user of the electronic device. This holistic approach may increase the visual appeal and functionality of the AoD and may extend the lifespan of the device by optimizing power consumption and reducing screen burn-in.

Referring now to the drawings, similar reference characters may denote corresponding features.

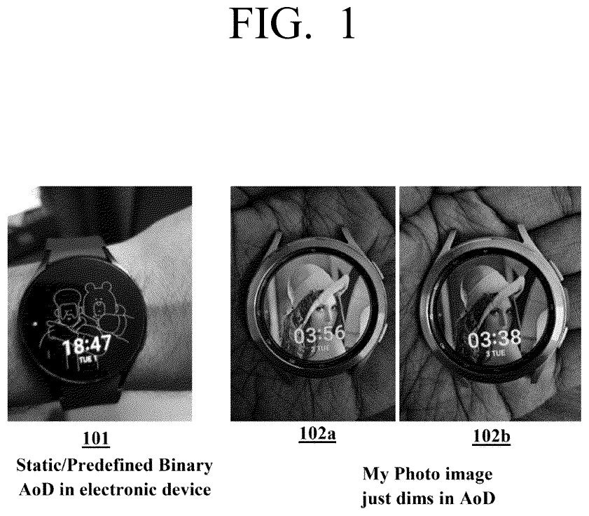

FIG. 1 is a schematic diagram that illustrates managing AoD (Always-on Display) of an electronic device. FIG. 1 illustrates different scenarios where the AoD is active in the electronic device, such as a smartwatch, demonstrating how the device adapts the display based on conditions (101). The FIG. 1 illustrates that the electronic device is capable of managing the AoD by displaying predefined or customized content. Further, when the battery level is low, the electronic device dims the AoD to conserve power (102).

In some methods, the management of AoD may focus on power consumption. For instance, when the battery level drops below a threshold, the device automatically dims the display or switches to a low-power mode to extend battery life. However, this approach does not take into account other factors that could enhance the user experience. For example, it does not consider the type of content being displayed or the user's current activity, which could be used in determining the display settings. Some methods may lack the ability to provide a seamless experience across multiple devices.

One or more embodiments may dynamically adapt the AoD based on device power consumption and on other user and device contexts such as user preferences, image type, emotional state, and device location. The AoD may display different types of content depending on what the user is doing or how they are feeling. For example, if the user is exercising, the AoD might display fitness-related information, while if the user is in a meeting, it might show a more discreet clock face. Furthermore, one or more embodiments may maintain consistent cross-device AoD content across multiple devices of the user, thus enhancing user personalization and ensuring consistency across all interconnected devices. This cross-device synchronization may facilitate a cohesive and integrated user experience, making it easier for users to manage their information and stay connected regardless of which device they are using.

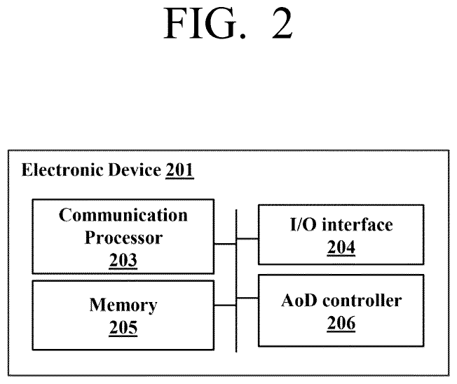

FIG. 2 is a block diagram of an electronic device (201) for managing the AoD according to one or more embodiments. With reference to FIG. 2, the electronic device (201) can encompass a diverse range of devices including, but not limited to, laptops, palmtops, desktops, mobile phones, smartphones, Personal Digital Assistants (PDAs), tablets, wearable devices, smartwatches, Internet of Things (IoT) devices, virtual reality devices, foldable devices, flexible devices, display devices, and immersive systems. In one or more embodiments, the electronic device (201) includes a memory (205), a communication processor (203), an Input/Output (I/O) interface (204), and an AoD controller (206).

The memory (205) is configured to store instructions to be executed by the communication processor (203). The memory (205) can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory (205) may, in some examples, be considered a non-transitory storage medium. The term non-transitory may indicate that the storage medium is not embodied in a carrier wave or a propagated signal. However, the term non-transitory should not be interpreted that the memory (205) is non-movable. In some examples, the memory (205) is configured to store larger amounts of information. In some examples, a non-transitory storage medium may store data that can over time change (e.g., in Random Access Memory (RAM) or cache).

The communication processor (203) may include one or a plurality of processors. The one or the plurality of processors may be a central processing unit (CPU), an application processor (AP), or the like, a graphics-only processing unit such as a graphics processing unit (GPU), a visual processing unit (VPU), and/or an AI-dedicated processor such as a neural processing unit (NPU). The communication processor (203) may include multiple cores and is configured to execute the instructions stored in the memory (205).

The I/O interface (204) transmits the information between the memory (205) and external peripheral devices. The peripheral devices are the input-output devices associated with the network apparatus. The I/O interface (204) receives several pieces of information from a plurality of UEs, network devices, servers, and the like.

In one or more embodiments, the AoD controller (206) of the electronic device (201) communicates with the processor (203), I/O interface (204), and memory (205) for managing the AoD of the electronic device (201). The AoD controller (206) receives candidate AoD content to be displayed on the electronic device (201) along with AoD contextual information and determines the AoD preferred pattern of the user of the electronic device (201) based on the candidate AoD content and the AoD contextual information. Further, the AoD controller (206) generates a set of variable AoD contents corresponding to the candidate AoD content based on the AoD preferred pattern of the user of the electronic device (201) and the AoD contextual information, wherein each AoD content of the set of AoD contents is generated for changes in the AoD contextual information. Furthermore, the AoD controller (206) displays the set of variable AoD contents on the electronic device (201).

In one or more embodiments, the AoD controller (206) determines at least one variable AoD content from the set of variable AoD contents based on a plurality of aesthetic parameters, wherein the plurality of aesthetic parameters comprises at least one of color schemes, font styles, and layout configurations that are dynamically adjusted based on ambient light conditions and user activity patterns. The at least one variable AoD content is displayed on the AoD of the electronic device (201) by the AoD controller (206). This dynamic adjustment may ensure the displayed AoD content is visually appealing and functionally effective under varying environmental conditions, thereby enhancing the user experience. The ability to adapt to ambient light conditions, for instance, is used to remain the display legible and aesthetically pleasing whether the user is in a brightly lit environment or a dimly lit one.

In one or more embodiments, the AoD controller (206) determines at least one cross-device AoD content from the set of variable AoD contents based on the AoD contextual information, wherein the at least one cross-device AoD content is consistent across multiple devices of the user of the electronic device. The at least one cross-device AoD content is displayed on the AoD of the electronic device (201) by the AoD controller (206). This cross-device consistency is used for a seamless user experience, allowing users to transition between devices without losing the contextual relevance of the displayed information. For example, if a user owns both a smartphone and a tablet, the AoD content displayed on both devices can be synchronized to show the same notifications, calendar events, or other pertinent information, thereby providing a unified and cohesive user experience across all devices.

In one or more embodiments, the AoD controller (206) determines the AoD contextual information by determining user context information based on a plurality of user parameters, wherein the plurality of user parameters comprises at least one of a behavior of the user, an emotional state of the user, user preferences, a user personality, and a user-defined AoD pattern. This user context information may be used for tailoring the AoD experience to the user. For example, if the user is known to frequently check their device for notifications during meetings, the AoD controller (206) may prioritize displaying calendar events and urgent messages during those times. Similarly, the emotional state of the user, which could be inferred from various sensor inputs or user interactions, might influence the type of content displayed, such as showing calming images or motivational quotes when the user is detected to be stressed.

Further, the AoD controller (206) determines the AoD contextual information by determining device context information based on a plurality of device parameters, wherein the plurality of device parameters comprises at least one of a screen configuration, battery information, temperature, location, time, and any user event of the electronic device. This device context information may be used to increase the AoD functionality for user satisfaction and for device performance and longevity. For instance, if the battery level is low, the AoD controller might reduce the brightness or limit the types of content displayed to conserve power. Similarly, location and time information can be used to provide relevant content, such as weather updates in the morning or traffic information during commute hours.

In one or more embodiments, the AoD controller (206) determines an effect weightage for each AoD preferred pattern of a plurality of AoD preferred patterns based on the AoD contextual information and stores the effect weightage for each AoD preferred pattern of the plurality of AoD preferred patterns. This effect weightage is a numerical representation of the relevance or importance of each AoD pattern in the given context. By storing these weightages, the AoD controller can quickly and efficiently adapt the AoD display to changing contexts without recalculating the relevance of each pattern from scratch. This dynamic adaptation is used to remain that the AoD display useful and engaging for the user while also being efficient in terms of resource usage.

In one or more embodiments, the AoD controller (206) segments the candidate AoD content (302) into a plurality of segments and generates a modified candidate AoD content by extracting salient segments from the plurality of segments based on the AoD contextual information. Further, the AoD controller (206) determines semantic features from the candidate AoD content as a whole, with the modified candidate AoD content comprising the salient segments of the candidate AoD content. This segmentation and extraction process allows the AoD controller (206) to present the relevant information to the user while limiting unnecessary details. For example, if the candidate AoD content (302) includes a lengthy news article, the AoD controller (206) might extract and display the headline and a brief summary, ensuring that the user can quickly grasp the information.

The AoD controller (206) is incorporated into the electronic device (201) through processing circuitry comprising logic gates, integrated circuits, microprocessors, microcontrollers, memory circuits, passive and active electronic components, optical components, hardwired circuits, or similar technologies. These circuits can be manifested in one or more semiconductor chips or on substrate supports such as printed circuit boards. This hardware-based approach may allow faster processing and lower power consumption compared to software-only solutions, and may be used for modern electronic devices that require both high performance and energy efficiency.

At least one of the plurality of components of the AoD controller (206) may be implemented through an AI model. A function associated with the AI model may be performed through the memory (205) and the processor (203). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that by applying a learning process to a plurality of learning data, a predefined operating rule or AI model of a characteristic is made. The learning may be performed in a device itself in which AI, according to one or more embodiments, is performed and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Whilst FIG. 2 depicts hardware components of the electronic device (201), the disclosure is not limited thereto. The electronic device (201) may comprise a greater number of hardware components, for example. Additionally, the labels or names assigned to these elements are for illustrative purposes and do not limit the scope of the disclosure. Furthermore, one or more components may be merged together to perform the same or a substantially similar function.

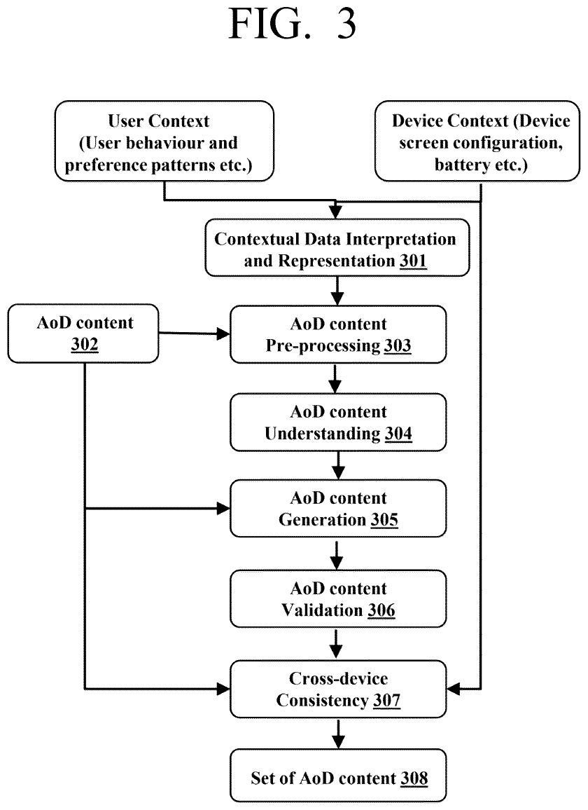

FIG. 3 is a block diagram that illustrates an architecture of the AoD controller (206) for managing the AoD of the electronic device (201) according to one or more embodiments. The architecture includes a contextual data interpretation and representation block (301), an AoD content pre-processing block (303), an AoD content understanding block (304), an AoD content generation block (305), an AoD content validation block (306), and a cross-device consistency block (307).

In one or more embodiments, the contextual data interpretation and representation block (301) determines the AoD contextual information, which includes external context information and internal context information of the electronic device (201). The external context information may encompass environmental factors such as ambient light, location, and time of day, while the internal context information may include device-specific parameters such as battery status, current applications in use, and user interaction history. Further, the contextual data interpretation and representation block (301) is responsible for determining and storing an effect weightage for each AoD preferred pattern of the plurality of AoD preferred patterns based on the AoD contextual information. This effect weightage that influences how the AoD content is displayed, ensuring that the relevant and contextually appropriate information is highlighted for the user.

In one or more embodiments, the AoD content pre-processing block (303) receives a candidate AoD content (302) from a plurality of resources of the electronic device (201) to be displayed on the electronic device (201) and the AoD contextual information from the contextual data interpretation and representation block (301). The AoD content pre-processing block (303) segments the candidate AoD content (302) to extract the most salient segment to be processed as the AoD. The AoD content pre-processing block (303) is responsible for extracting the salient and relevant features of the candidate AoD content (302) based on the AoD contextual information, minimizing the background details to highlight the segment of significance in the AoD mode and generates the modified AoD content. In one or more embodiments, the candidate AoD content (302) can be, but is not limited to, text, audio, images, animations, video, short video, GIFs, interactive content, etc. In one or more embodiments, the candidate AoD content (302) can be user-selected or selected from a gallery based on user-planned activities in the electronic device (201) by the AoD controller (206). In one or more embodiments, the candidate AoD content (302) is selected dynamically from the plurality of resources of the electronic device (201) based on the AoD contextual information.

In one or more embodiments, the AoD content understanding block (304) extracts semantic features from the modified AoD content through understanding the modified AoD content as a whole and finalizes the effect/pattern to be applied to the modified AoD content based on the effect weightage and the AoD contextual information. The AoD content understanding block (304) determines the AoD preferred pattern of the user of the electronic device (201) based on the candidate AoD content (302) and the AoD contextual information. This process involves analyzing the user's interaction patterns and preferences, ensuring that the displayed AoD content is contextually relevant and aligns with the user's aesthetic and functional preferences. By leveraging advanced machine learning algorithms, the AoD content understanding block (304) can predict and adapt to the user's preferences over time, enhancing the overall user experience.

In one or more embodiments, the AoD content generation block (305) generates a set of variable AoD contents (308) corresponding to the candidate AoD content (302) based on the AoD preferred pattern of the user of the electronic device (201) and the AoD contextual information, wherein each AoD content of the set of AoD contents (308) is generated for changes in the AoD contextual information. The AoD content generation block (305) generates the set of variable AoD contents (308) considering the timeline of change in the AoD contextual information, such as battery status, emotional state, and other dynamic factors. This is used to remain the AoD content relevant and useful to the user, adapting in real-time to any changes in context. For instance, if the device's battery is low, the AoD content generation block (305) may prioritize displaying notifications or information that may require immediate attention, while minimizing other content.

In one or more embodiments, the AoD content generation block (305) determines at least one AoD content creation method of a plurality of AoD content creation methods based on a type of the candidate AoD content (302) and the AoD contextual information. This contextual information may include factors such as user preferences, historical usage patterns, and environmental conditions. By analyzing these factors, the AoD content generation block (305) prioritizes the selected AoD content creation method over the remaining methods to make the generated content relevant for the user. The block then generates a set of variable AoD contents (308) corresponding to the candidate AoD content (302) by applying the prioritized creation method. This process is guided by the AoD preferred pattern of the user and the AoD contextual information, ensuring that the content is tailored to the user.

In one or more embodiments, the set of variable AoD contents (308) corresponding to the candidate AoD content (302) comprises diverse informational elements selectable for persistent low-power display on the electronic device (201) screen, encompassing time, date, battery level, notifications, ambient light conditions, user-defined graphics/patterns, media playback controls, calendar events, weather updates, and customizable combinations thereof, dynamically adapting content based on the user preferences, the device status, and environmental factors. Additionally, the set of variable AoD content (308) can be customized with user-defined graphics and patterns, adapting its appearance and information based on factors such as user mood, device location, and battery life. The electronic device (201) employs various content creation methods and a validation framework to ensure content relevance, accuracy, aesthetic appeal, and consistency across multiple devices.

In one or more embodiments, the AoD content validation block (306) determines at least one variable AoD content from the set of variable AoD contents (308) based on a plurality of aesthetic parameters. These parameters include, but are not limited to, color schemes, font styles, and layout configurations. The aesthetic parameters are dynamically adjusted based on ambient light conditions and user activity patterns is used for visibility and appeal. The AoD content validation block (306) is responsible for validating and ensuring that the generated set of AoD content (308) is aesthetically pleasing to the end user. This involves calculating aesthetic scores for each piece of content and retaining the at least one variable AoD content that surpasses a calculated threshold.

In one or more embodiments, the cross-device consistency block (307) determines at least one cross-device AoD content from the set of variable AoD contents (308) based on the AoD contextual information. The cross-device consistency block (307) takes into account the varying screen sizes, resolutions, and capabilities of these devices to maintain a uniform user experience. Once the consistent AoD content is determined, it is displayed on the AoD of the electronic device (201). This may be used by users who frequently switch between devices, for example, as it provides a seamless and cohesive visual experience across all of their electronic gadgets.

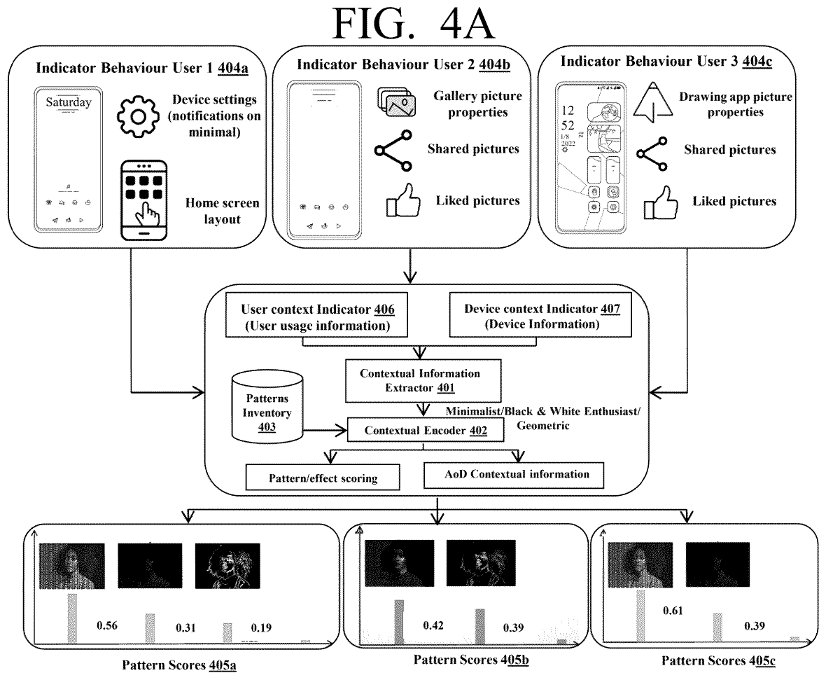

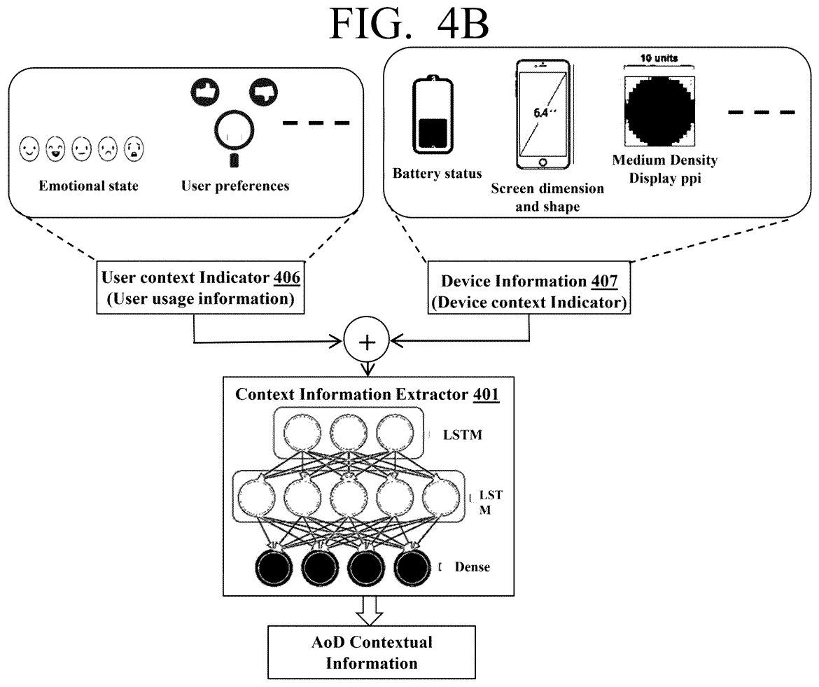

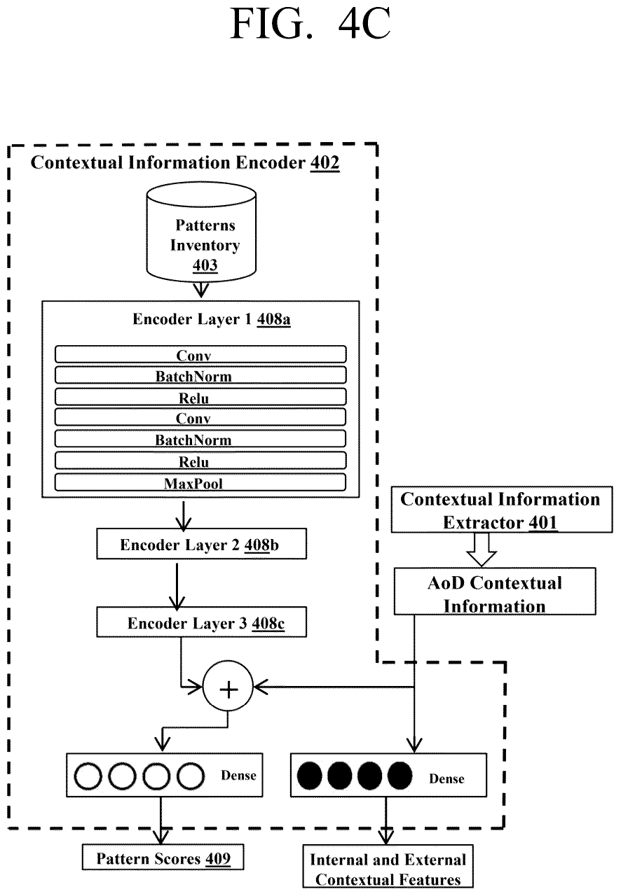

FIG. 4A is a schematic diagram that illustrates a method of context interpretation and representation for managing the AoD of the electronic device (201) according to one or more embodiments. The contextual data interpretation and representation block (301) determines the AoD contextual information and the effects weightage. The contextual data interpretation and representation block (301) may include a contextual information extractor (401) and a contextual encoder (402). As illustrated in FIG. 4A, the user behavior and device status (404a-404c) are dynamically monitored by the contextual data interpretation and representation block (301), which includes a user context indicator (406) and a device context indicator (407).

In one or more embodiments according to the scenario of the user device usage information, the contextual information extractor (401) determines the user preference/personality, which is then encoded by the contextual encoder (402). For each pattern/effect stored in a pattern inventory (403), the effect weightage is allocated based on the user context information and the device context information of the electronic device (201). The user behavior (404a-404c) includes, for example, device settings (notifications minimal), home screen layout, gallery picture properties, shared pictures, liked pictures, drawings, and app pictures. As illustrated in FIG. 4A, each pattern is assigned with the effects weightage (405a-405c), which is a numerical value.

The contextual data interpretation and representation block (301) operates by continuously gathering and analyzing data from both the user and the device to ensure that the AoD content is always relevant and personalized. This dynamic monitoring allows the system to adapt to changes in user behavior and device status in real-time. For instance, if the user frequently changes their home screen layout or shares many pictures, the system can adjust the AoD content to reflect these preferences. Similarly, if the device status changes, such as a drop in battery level, the system can modify the AoD content to conserve energy while still providing useful information to the user.

FIG. 4B is a schematic diagram that illustrates the contextual information extractor (401) of the context interpretation and representation block (301) according to one or more embodiments. The contextual information extractor (401) processes the user and device context information, which is then utilized to dynamically generate the set of AoD content (308). The device context information includes data related to the electronic device (201) itself, such as battery level, screen dimensions, and display type. The user context information encompasses data pertaining to the user, including preferences, emotional state, and location. The contextual information extractor (401) employs various AI models, including Long Short-Term Memory (LSTM) and Dense layers, to process and represent the input contextual information. Components depicted in FIG. 4B include device information (device context indicator) representing the source of data related to the electronic device, and user context indicator (user usage information) representing the source of data pertaining to the user. The contextual information extractor (401) is responsible for processing both user and device context information using AI models, with the dense layer being used for classification and information representation tasks. The AoD contextual information extractor includes both the internal and external context information.

The use of AI models such as LSTM and Dense layers may allow the system to handle complex and varied data inputs. LSTM models may be used for understanding sequences and patterns in data, such as analyzing user behavior over time. Dense layers, on the other hand, are excellent for classification tasks, enabling the system to categorize different types of contextual information accurately. By leveraging these advanced AI techniques, the contextual information extractor (401) can provide a nuanced and detailed understanding of both user and device contexts, leading to more personalized and AoD content.

FIG. 4C is a schematic diagram that illustrates the contextual encoder (402) of the context interpretation and representation block (301) according to one or more embodiments. The primary function of the contextual encoder (402) is to process the contextual information extracted by the contextual information extractor (401) and assign an initial effects score for each visual effect/pattern stored within the effects/patterns inventory (403). These initial scores are determined solely based on the analyzed contextual information. The contextual encoder (402) receives the AoD contextual information extracted from user and device data. The contextual encoder (402) utilizes appropriate processing techniques to encode the AoD contextual information into a suitable format. This encoded data is subsequently employed to evaluate each visual effect/pattern stored within the effects inventory (403). Based on this evaluation and considering the contextual information, the contextual encoder (402) assigns an initial effects score (409) to each effect/pattern.

The process of encoding and scoring the contextual information ensures that each visual effect or pattern displayed on the AoD is tailored to the specific context of the user and the device. This approach may improve the user experience by making the AoD more relevant and engaging but also optimizes the use of device resources. For example, if the device's battery is low, the system might prioritize displaying less resource-intensive effects. Conversely, the system might choose effects that are more likely to resonate with an emotional state of the user. This level of customization may be facilitated by encoding and scoring mechanisms employed by the contextual encoder (402).

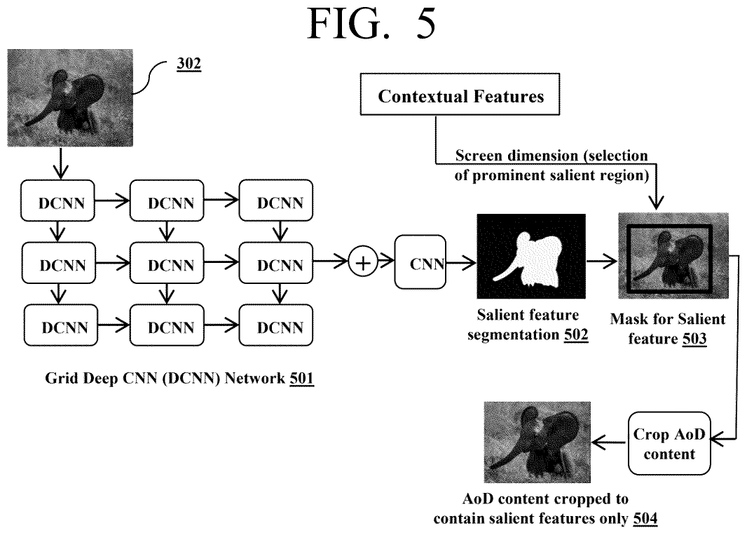

FIG. 5 is a schematic diagram that illustrates the AoD content pre-processing block (303) for managing AoD of the electronic device (201) according to one or more embodiments. The AoD content pre-processing block (303) is responsible for extracting the salient and relevant features of the candidate AoD content (302) based on the AoD contextual information, minimizing the background details to highlight the segment of significance in the AoD mode, and generates a modified AoD content. The salient features of the candidate AoD content (302) are identified and segmented using a Grid DCNN (501) pipeline. The AoD content pre-processing block (303) determines the salient features (502) of the candidate AoD content (302) to be retained for maintaining good aesthetics when utilized for different device configurations. For example, smart watch small screen dimension>compact image>less details; Phone>more details.

The Grid DCNN (501) pipeline includes deep convolutional neural networks to analyze and process the candidate AoD content (302). This pipeline is designed to work efficiently by dividing the content into a grid structure, allowing for parallel processing of different segments of the image. Each segment is analyzed to identify features such as edges, textures, and objects for the AoD display. Based on these salient features, the system may preserve aspects of the content while minimizing extraneous details.

Moreover, the AoD content pre-processing block (303) is adaptive to various device configurations, ensuring that the modified AoD content is appropriately scaled and detailed according to the display characteristics of the target device. For instance, when the AoD content is intended for a smart watch with a smaller screen, the pre-processing block will generate a more compact image with fewer details to fit the limited display area. Conversely, for a smartphone with a larger screen, the pre-processing block can retain more details and provide a richer visual experience. This adaptability is achieved through a combination of machine learning algorithms and contextual analysis, which together enable the system to dynamically adjust the content based on the specific requirements of each device, thereby enhancing user experience across different platforms.

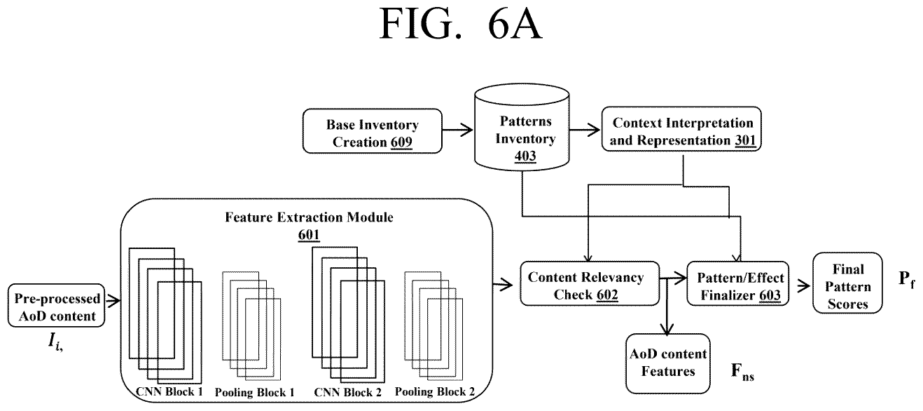

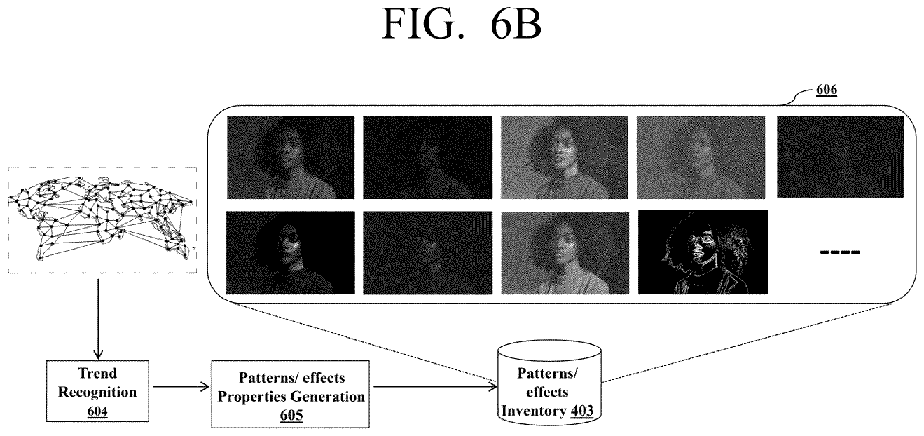

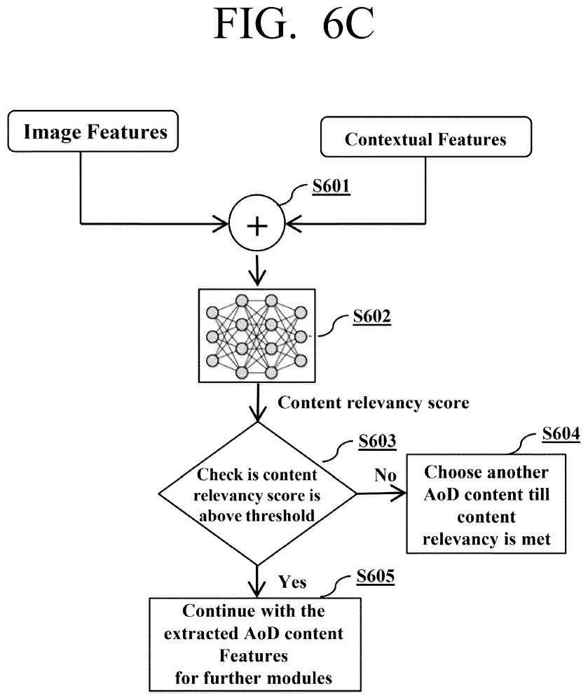

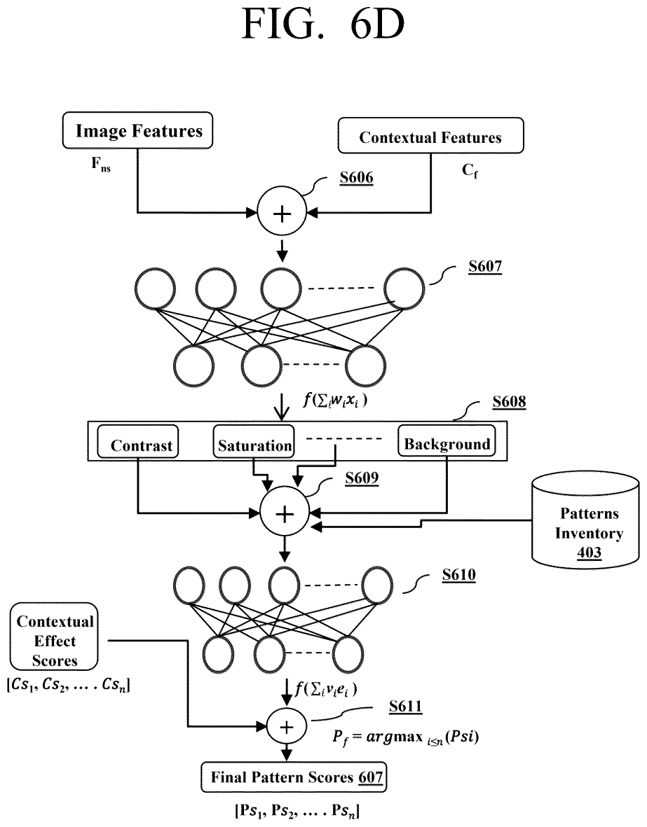

FIG. 6A is a schematic diagram that illustrates the AoD content understanding block (304) for managing the AoD of the electronic device (201) according to one or more embodiments. The AoD content understanding block (304) extracts semantic features from the modified AoD content through understanding the modified AoD content as a whole and finalizes the effect/pattern to be applied to the modified AoD content based on the effect weightage and the AoD contextual information. The AoD content understanding block (304) includes a feature extraction module (601), a content relevancy check module (602), and a pattern/effect finalizer (603). The feature extraction module (601) applies two-layer Convolution layers to the pre-processed AoD content/modified AoD content Iij, extracting the features which are then passed to various content filters. The content relevancy check module (602) extracts the AoD content features Fns based on the AoD contextual information received from the context interpretation and representation block (301). The pattern/effect finalizer (603) determines final pattern scores Pf for each pattern/effect stored in the pattern inventory (403) based on the AoD contextual information.

The feature extraction module (601) is designed to handle a variety of AoD content types, controlling feature extraction across different visual styles and formats. By employing two-layer Convolution layers, the module may capture low-level and high-level features. This preprocessing operation may ensure features are forwarded to the appropriate modules, thereby increasing the performance of the AoD content understanding block (304). The extracted features may be used to assess the content's alignment with user preferences and contextual information, to facilitate a personalized AoD experience.

FIG. 6B is a schematic diagram that illustrates a method of base inventory creation for the AoD content understanding according to one or more embodiments. Base inventory (609) creation involves observing and analyzing global trends in AoD content design. Data sources for trend recognition (604) can include big data analysis and manual searching of social media platforms. Based on the observed trends, the effects properties generation (605) operation entails identifying properties or characteristics for generating new AoD content that aligns with current trends. This might involve an engineering effort to understand the underlying design principles behind trending AoD visuals. Leveraging the identified properties, an algorithm or a set of instructions is created for generating new trending AoD content. The algorithm can be implemented within the system to automatically produce novel AoD effects/patterns (606). Once new effects/patterns (606) are generated using the algorithm, they are incorporated into the effects inventory (403). This ensures the AoD system remains current with the latest trends in AoD design.

The base inventory (609) creation method offers enhanced personalization by incorporating trending AoD content, providing users with a broader range of visually appealing and up-to-date options for their AoD displays. It improves the user experience by allowing the AoD content understanding block (304) to dynamically adapt to user preferences and popular design trends, resulting in a more engaging AoD experience. Additionally, it ensures content relevance by generating effects and patterns aligned with current user interests and design aesthetics. This dynamic approach to inventory creation may keep the AoD system relevant and may foster continuous innovation in AoD content design, thereby maintaining user engagement and satisfaction over time.

FIG. 6C is a schematic diagram that illustrates the content relevancy check module (602) for the AoD content understanding according to one or more embodiments. The content relevancy check module (602) analyzes the AoD content features and compares them to the user's contextual information (S602). When the AoD content aligns with the user's preferences (e.g., an image containing a dog for a dog lover), the module approves the image for the AoD. Otherwise, the module prompts a search for a different image until a relevant one is found. At operation S601, the content relevancy check module (602) receives the AoD content features extracted by the feature extraction module (601) and the AoD contextual information extracted by the contextual data interpretation and representation block (301). At operation S602, the content relevancy check module (602) determines a content relevancy score for the AoD content and determines whether the content relevancy score meets a predefined threshold (S603). At S604, when the content relevancy score does not meet the predefined threshold, another AoD content is chosen to check the content relevancy score. At operation S605, when the content relevancy score meets the predefined threshold, the AoD content is passed to the subsequent modules.

The content relevancy check module (602) is responsible for ensuring that AoD contents with no significant relevance to the user are not chosen to be shown in the AoD mode when the AoD content is automatically chosen. In case the AoD content is chosen by the user manually, this relevancy check can be overridden by the user preference. This dual-mode operation-automatic and manual-provides flexibility and control to the user, enhancing the overall user experience. By filtering out irrelevant content, the module ensures that the AoD display remains meaningful and engaging, thereby increasing user satisfaction and interaction with the device.

FIG. 6D is a schematic diagram that illustrates the pattern finalizer (603) for the AoD content understanding according to one or more embodiments. The pattern finalizer (603) may determine the pattern with the highest match based on the type of the candidate AoD content (302) and the AoD contextual information. The inputs include the AoD content features from the feature extraction module (601) and the AoD contextual information from the contextual data interpretation and representation block (301). The output is the final pattern scores (607) for each pattern in the effect inventory (403). The pattern finalizer (603) module assigns final scores (607) to each effect or pattern in the inventory (403), so that an effect with the highest probability or score may be displayed to the user.

The AoD content features such as contrast, saturation, etc., are extracted from the AoD content features Fns and contextual features Cf, which are then processed using another dense layer. The final pattern Pf is determined from the final pattern scores (607). This scoring mechanism may facilitate selecting contextually relevant and visually appealing patterns, which may increase aesthetic qualities of the AoD display. By continuously updating the pattern inventory (403) based on user feedback and emerging trends, the pattern finalizer (603) ensures that the AoD system remains dynamic and responsive to user preferences, thereby providing a personalized and engaging user experience.

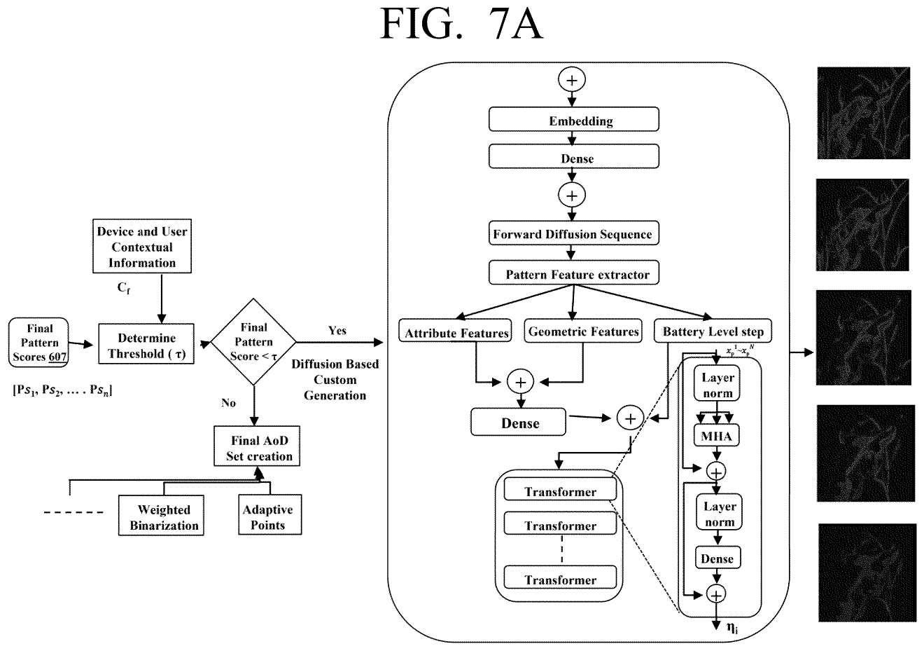

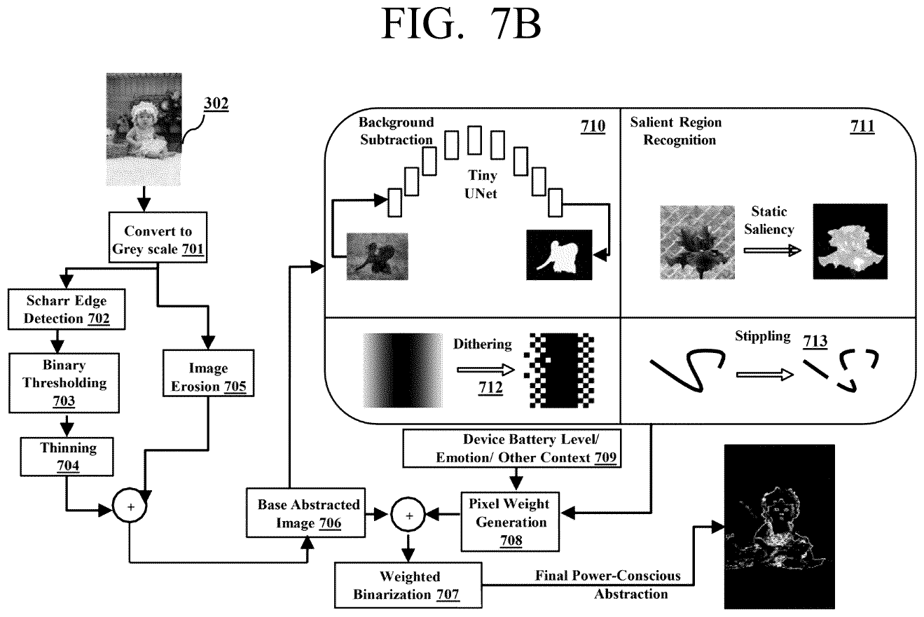

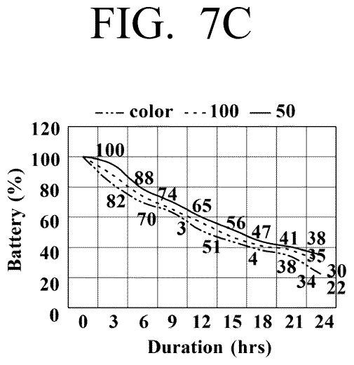

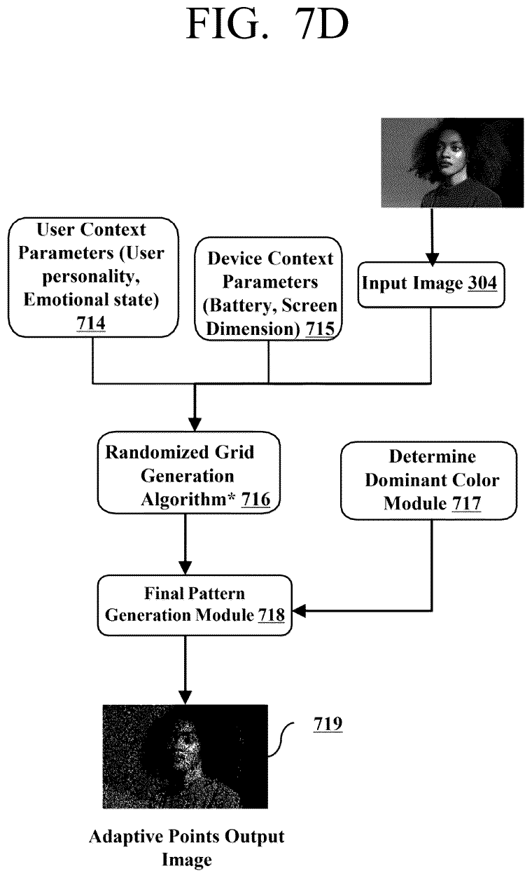

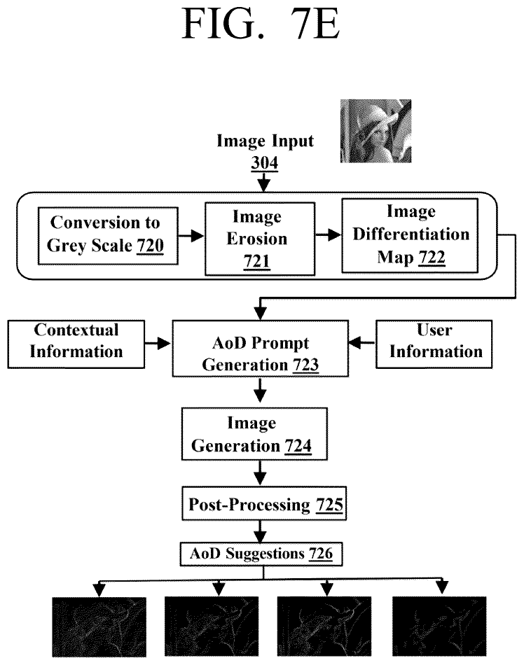

FIG. 7A is a schematic diagram that illustrates a method of generating the set of variable AoD contents (308) for managing AoD of the electronic device according to one or more embodiments. The AoD content generation block (305) generates a set of variable AoD contents (308) corresponding to the candidate AoD content (302) based on the AoD preferred pattern of the user of the electronic device (201) and the AoD contextual information, wherein each AoD content of the set of AoD contents (308) is generated for changes in the AoD contextual information. The AoD content generation block (305) generates the set of variable AoD contents (308) considering the timeline of change in the AoD contextual information, such as generating content corresponding to context changes like battery status, emotional state, etc.

In one or more embodiments, the AoD content generation block (305) determines the at least one AoD content creation method of the plurality of AoD content creation methods based on the type of the candidate AoD content (302) and the AoD contextual information. The plurality of AoD content creation methods include, but are not limited to, the weighted binarization method, adaptive points method, diffusion-based model method, adaptive brightness method, etc. The AoD content generation block (305) employs an algorithmic decision maker to select the at least one AoD content creation method from the plurality of AoD content creation methods based on the type of the candidate AoD content (302) and the AoD contextual information. Further, the AoD content generation block (305) employs the selected AoD content creation methods to generate the set of variable AoD content (308).

Additionally, the AoD content generation block (305) is designed to be highly adaptive and responsive to real-time changes in contextual information. For instance, if the battery level of the electronic device (201) drops below a threshold, the AoD content generation block (305) can dynamically adjust the brightness and complexity of the AoD content to conserve battery life. Similarly, if the user's emotional state, detected through biometric sensors or user interactions, indicates stress or fatigue, the AoD content generation block (305) can modify the AoD content to display visuals or notifications in a less intrusive manner. This adaptability ensures that the AoD content remains relevant and useful to the user, enhancing the overall user experience.

In one or more embodiments, the AoD content generation block (305) determines a threshold (τ) to decide the use of either diffusion-based pattern generation or any other pre-determined algorithms for the creation of the set of variable AoD content (308). This threshold (τ) can be dynamically adjusted based on various factors such as user preferences, historical data, and current device status. The final output of the AoD content generation block (305) is a set of AoD content corresponding to different battery levels and AoD contextual information. This may ensure the AoD content aesthetically pleasing but also functionally optimized for various operating conditions, thereby providing a seamless and efficient user experience.

FIG. 7B is a schematic diagram that illustrates a method of generating the set of AoD content (308) using the weighted binarization method according to one or more embodiments. For illustrative purposes, FIG. 7B describes the method of AoD image creation using the weighted binarization method; however, the method can be extended to other AoD contents as well. The AoD content generation block (305) modifies the input image (302) based on extracted AoD contextual information. Techniques such as static saliency (711), dithering (712), or stippling (713) may be applied to adjust the image according to context. The modified image is then converted into a binary format (Binary Image/Thresholding) suitable for AoD display. Further refinements like erosion (705) or thinning (704) may be used to manipulate the binary image. Additional contextual factors such as emotion or other context can also influence the AoD generation process. The AoD content generation block (305) creates a base abstract image (706) (Base Abstracted Image) as the foundation for the final AoD content. The weighted binarization (707) method is then applied, assigning weights (708) to image elements based on contextual information, prioritizing elements relevant to the user's current state or preferences. Finally, the AoD content generation block (305) generates a power-conscious abstraction (Final Power-Conscious Abstraction) considering both visual quality and energy efficiency requirements. In summary, the AoD content generation block (305) uses AoD contextual information to dynamically create and customize AoD content through a weighted binarization method, ensuring user relevance and power efficiency.

FIG. 7C is a graphical representation illustrating the effects of employing the weighted binarization for the AoD content creation on the battery life of the electronic device (201), according to one or more embodiments. The graph demonstrates a significant improvement in battery life when the weighted binarization method is employed compared to traditional methods. Battery performance may be increased based on prioritizing and displaying contextually relevant elements of the image, thereby reducing the overall power consumption. The weighted binarization method balances the trade-off between maintaining high visual quality and conserving battery life, making it a solution for AoD content generation in modern electronic devices.

FIG. 7D is schematic diagram that illustrates a method of generating the set of AoD content (308) using the adaptive points method, according to one or more embodiments. The FIG. 7D outlines the method for generating an adaptive points output image (719) using an adaptive points algorithm. The adaptive points algorithm is designed to optimize image display for power efficiency. The algorithm dynamically adjusts the number and location of illuminated pixels (non-black) within an image, resulting in a visually similar but energy-conserving representation. By reducing the number of active pixels, the algorithm contributes to extended device battery life without significantly compromising image quality. The input image (304) is processed, considering user preferences (714) and device context (715). A randomized grid generation algorithm (716) creates a sampling grid over the input image (304). Dominant colors are determined (717) to inform color palette selection. A final pattern generation module (718) utilizes the grid, dominant colors, and other parameters to produce the stylized output image (719), which represents the original image using a set of points while preserving visual information and reducing complexity.

FIG. 7E is schematic diagram that illustrates a method of generating the set of AoD content (308) using the diffusion network method, according to one or more embodiments. Diffusion models for image generation work by gradually adding noise to the original images until the original images become random. Then, a neural network is trained to reverse this process and denoise the corrupted images. By learning how the images change when noise is added, the diffusion model can generate new images that resemble the original data distribution. This approach allows for high-quality image generation, even for complex scenes and objects.

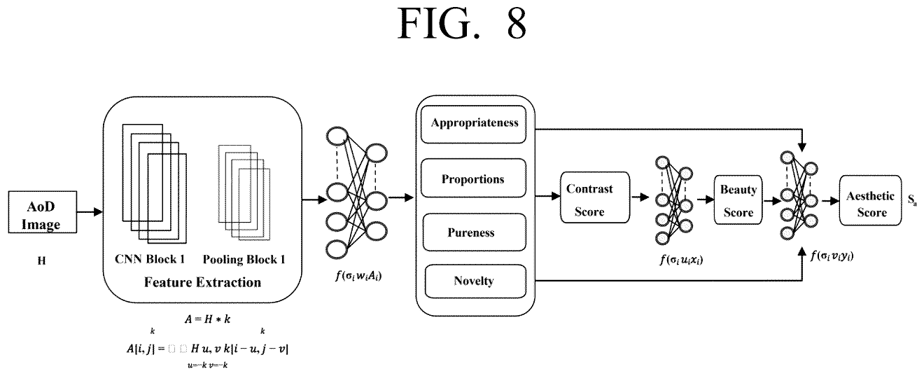

FIG. 8 is a schematic diagram that illustrates a method of AoD content validation for managing the AoD of the electronic device according to one or more embodiments. The AoD content validation block (306) is responsible for validating and ensuring that the generated set of AoD content (308) is aesthetically pleasing to the end user. Thus, the AoD content validation block (306) retains at least one variable AoD content that surpasses the calculated threshold after calculating the corresponding aesthetic scores. To determine the aesthetic effect of the generated set of AoD content (H) (308), features are extracted using a convolutional layer followed by flattening and a dense layer with weights w′. Various features like novelty, symmetry, color harmony, and balance are used to determine the final aesthetic score Sa. Based on the final aesthetic score, whether the generated set of AoD content (308) is aesthetically pleasing to the user is determined.

The convolutional layer is designed to capture intricate patterns and details in the AoD content, which are used for assessing its aesthetic quality. By applying filters across the AoD content, the convolutional layer extracts high-level features that contribute to the overall visual appeal. After the convolutional layer, the flattening process transforms the multi-dimensional output into a one-dimensional array, making it suitable for further processing by the dense layer. The dense layer, equipped with weights w′, then processes this array to compute the aesthetic score Sa. This score is a quantitative measure of the aesthetic quality of the AoD content, taking into account various features such as novelty, symmetry, color harmony, and balance.

Once the aesthetic score Sa is calculated, the AoD content validation block (306) compares it against a predefined threshold. If the score surpasses this threshold, the AoD content is deemed aesthetically pleasing and is retained for display on the electronic device. This process may facilitate the most visually appealing AoD content being presented to the user, enhancing their overall experience. Additionally, the system can be configured to continuously learn and adapt its aesthetic criteria based on user feedback, further refining the selection process over time. This dynamic approach allows the electronic device to consistently deliver high-quality AoD content that aligns with the evolving preferences of its users.

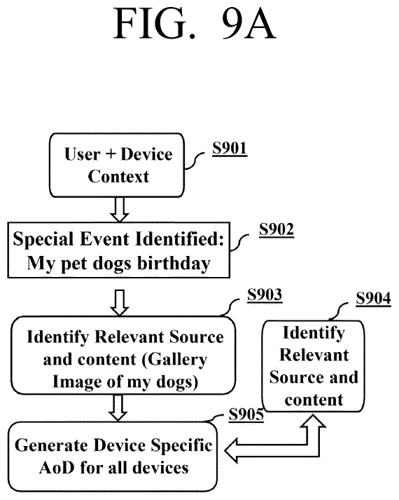

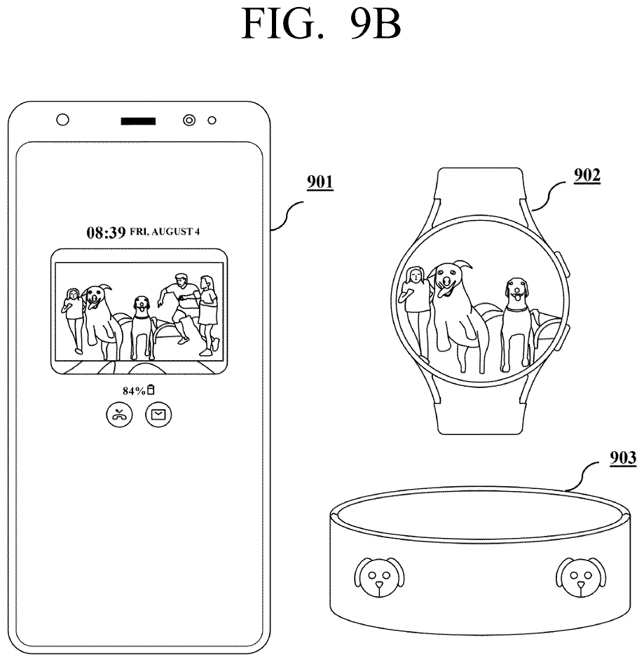

FIG. 9A is a flow diagram that illustrates a method of generating consistent cross-device AoD content across multiple devices of the user according to one or more embodiments. At operation S902, based on the AoD contextual information, the electronic device (201) determines any special event using the cross-device consistency block (307). For example, it might identify an event like my pet dog's birthday. This determination can be made by analyzing calendar entries, reminders, or other contextual data sources that the device has access to. The cross-device consistency block (307) ensures that the identified event is relevant and significant enough to warrant a change in the AoD content.

At operation S903 and S904, the relevant source and content are then identified based on the determined special event in the electronic device (201), such as locating gallery images of the pet dog. The system may search through various data repositories, including photo galleries, social media accounts, and cloud storage, to find the most appropriate and meaningful content related to the special event. For instance, it might prioritize recent images or those tagged with specific metadata indicating their relevance to the event. Accordingly, the content displayed may be pertinent and personalized to the user's preferences and context.

At operation S905, subsequently, the cross-device consistency block (307) generates the device-specific cross-device AoD content for all interconnected devices. This involves formatting the content to fit the display specifications of each device, whether it be a smartphone, tablet, smartwatch, or any other compatible device. The cross-device consistency block (307) then displays the at least one determined cross-device AoD content on the AoD of the electronic device (201). This synchronized display ensures a seamless user experience, where all devices present a unified and cohesive visual representation of the special event.

FIG. 9B illustrates an example of achieving the consistent cross-device AoD content across multiple devices of the user according to one or more embodiments. The illustration depicts various devices such as smartphones, tablets, and smartwatches, all displaying the same AoD content related to the special event. This visual consistency is achieved through the intelligent coordination of the cross-device consistency block (307), which ensures that each device receives the appropriately formatted content. The figure may also highlight the seamless transition of content updates, showing how changes made on one device are instantly reflected across all others. This exemplifies the robustness and efficiency of the system in maintaining a synchronized and engaging user experience.

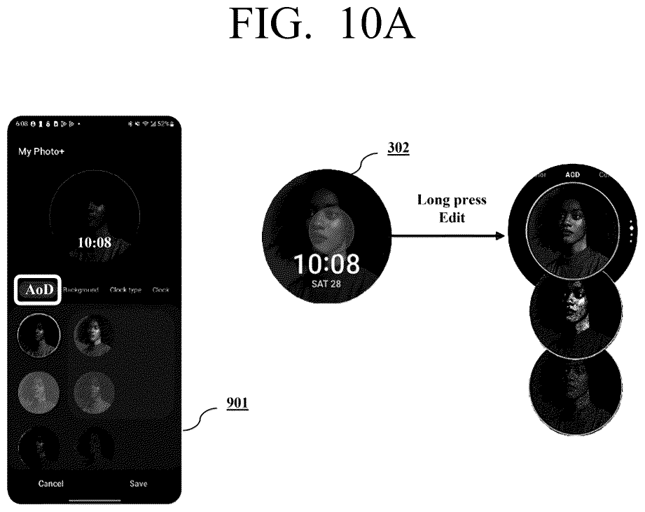

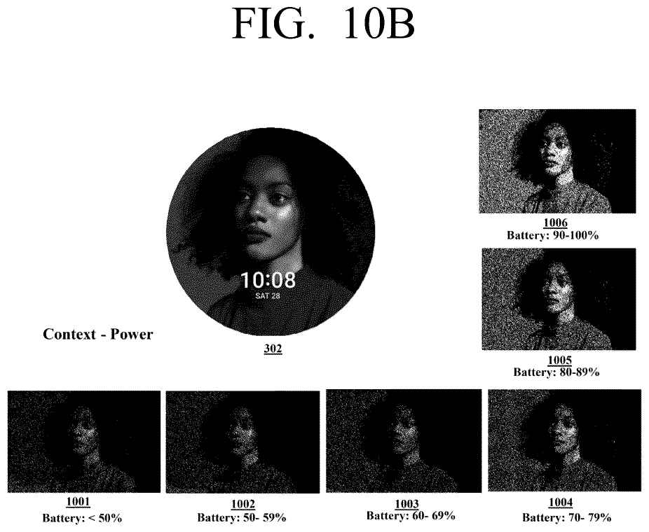

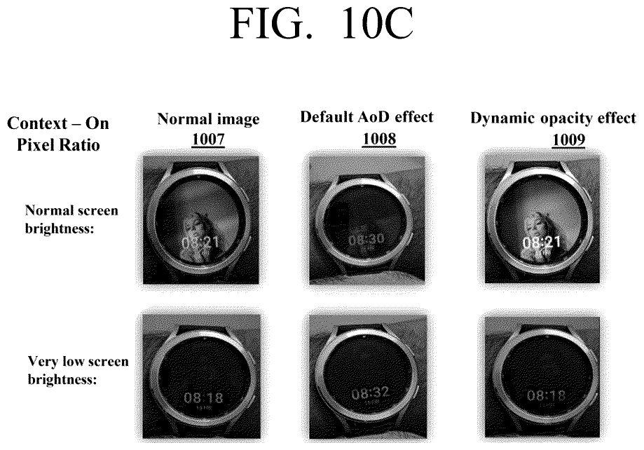

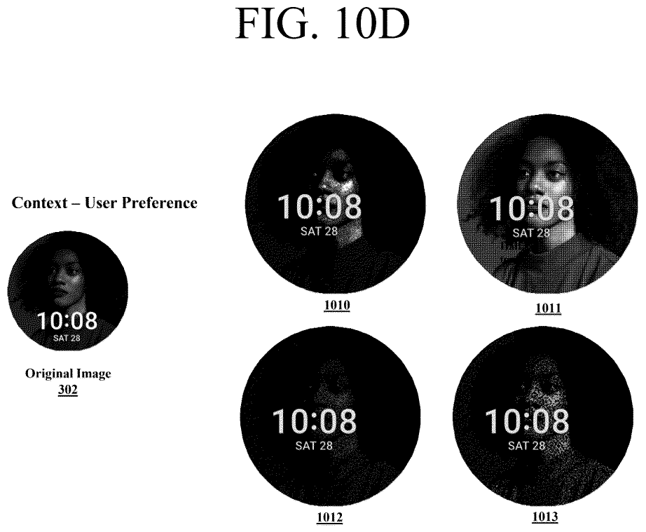

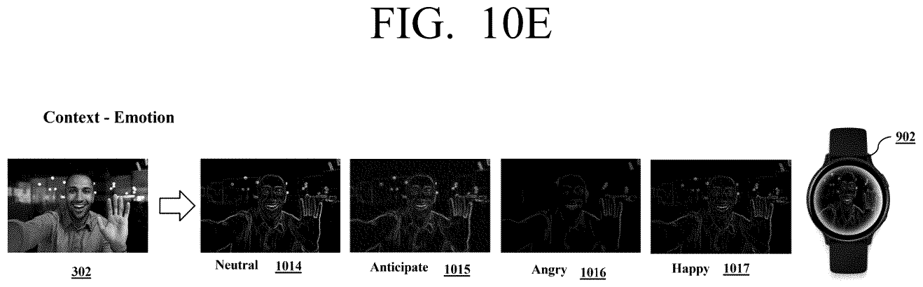

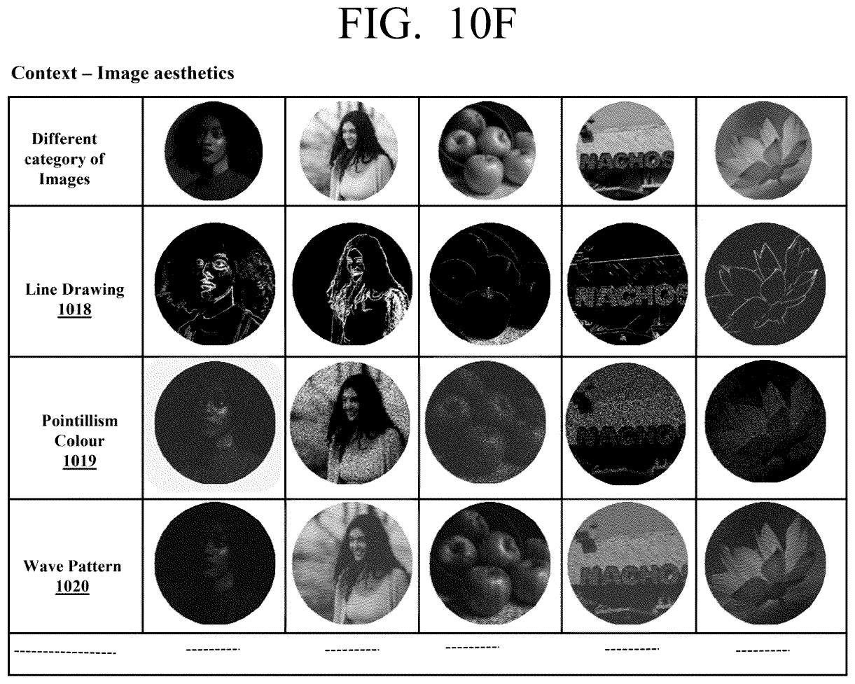

FIG. 10A illustrates a uses case of dynamic AoD customization of the electronic device (201), according to one or more embodiments. The FIG. 10A shows the various ways prioritizing the AoD variations provided to the user, when the user wants to select a variation of AoD.

FIG. 10B illustrates a uses case of dynamic AoD customization based on the internal context of the electronic device (201), according to one or more embodiments. As shown in the FIG. 1B, the pattern and brightness of the set of AoD content (308) is varied corresponding to the different battery level of the electronic device (201). The FIG. 10B shows the various variations of the patterns generated from a given image based on battery level as a context. The final image includes more features when battery level is high and the final image includes less features when the battery level is low.

FIG. 10C illustrates a uses case of dynamic AoD customization based on pixel ratio of the AoD content in the electronic device (201), according to one or more embodiments. Here, the number of pixel which are on when an image is selected is considered as a context. Beyond a threshold, screen brightness may be adjusted for dark images so that AoD is more visible.

FIG. 10D illustrates a uses case of user perception based AoD customization of the electronic device (201), according to one or more embodiments. The FIG. 10D shows variations based on user preference. For example a user prefers black and white images as AoD, for them black and white generated AoD variations are prioritized.

FIG. 10E illustrates a uses case of dynamic AoD customization based on the external context of the electronic device (201), according to one or more embodiments. In this scenario external context, such as emotion derived from direct/indirect user input can be used to customize the AoD. Different colors of the AoD may represent different user emotions, for example.

FIG. 10F illustrates a uses case of image features based AoD customization of the electronic device (201), according to one or more embodiments. FIG. 10F illustrates image prioritization based on aesthetic score. For example, a type of image wave pattern may generate higher aesthetic score, and therefore, the image with wave pattern may be prioritized.

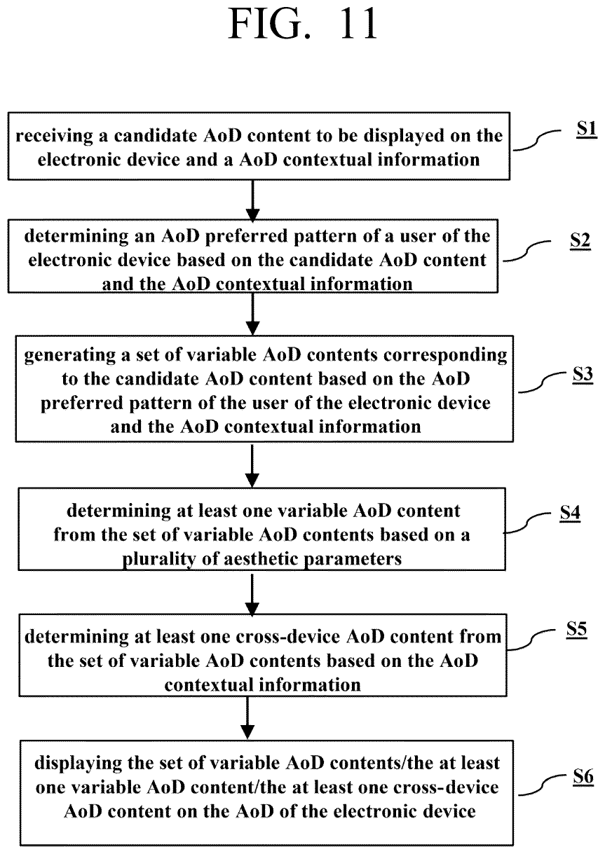

FIG. 11 is a flow chart that illustrates a method of managing the AoD of the electronic device (201) according to one or more embodiments. At operation S1, the electronic device (201) receives the candidate AoD content (302) from a plurality of resources of the electronic device (201) to be displayed on the electronic device (201) and the AoD contextual information from the contextual data interpretation and representation block (301).

At operation S2, the electronic device (201) determines the AoD preferred pattern of the user of the electronic device (201) based on the candidate AoD content (302) and the AoD contextual information. In one or more embodiments, the electronic device (201) extracts semantic features from the modified AoD content through understanding the modified AoD content as a whole and finalizes the effect/pattern to be applied to the modified AoD content based on the effect weightage and the AoD contextual information. This operation involves sophisticated algorithms that analyze user preferences and contextual data to tailor the AoD content. In one or more embodiments, the electronic device (201) determines an effect weightage for each AoD preferred pattern of a plurality of AoD preferred patterns based on the AoD contextual information and stores the effect weightage for each AoD preferred pattern of the plurality of AoD preferred patterns. By assigning weightages, the device can prioritize some patterns over others, and relevant content may be displayed.

At operation S3, the electronic device (201) generates the set of variable AoD contents (308) corresponding to the candidate AoD content (302) based on the AoD preferred pattern of the user of the electronic device (201) and the AoD contextual information, wherein each AoD content of the set of AoD contents (308) is generated for changes in the AoD contextual information. In one or more embodiments, the electronic device (201) generates the set of variable AoD contents (308) considering the timeline of change in the AoD contextual information, such as generating content corresponding to context changes like battery status, emotional state, etc. This dynamic generation of AoD content is used to remain the display relevant and engaging, adapting to changes in the user's environment and state. In one or more embodiments, the electronic device (201) determines the at least one AoD content creation method of the plurality of AoD content creation methods based on the type of the candidate AoD content (302) and the AoD contextual information and prioritizes the at least one AoD content creation method over the remaining AoD content creation methods based on the type of the candidate AoD content (302) and the AoD contextual information. The electronic device (201) generates the set of variable AoD contents (308) corresponding to the candidate AoD content (302) by applying the at least one prioritized AoD content creation method based on the AoD preferred pattern of the user and the AoD contextual information.

At operation S4, the electronic device (201) determines the at least one variable AoD content from the set of variable AoD contents (308) based on a plurality of aesthetic parameters, wherein the plurality of aesthetic parameters comprises at least one of color schemes, font styles, and layout configurations that are dynamically adjusted based on ambient light conditions and user activity patterns. The electronic device (201) is responsible for validating and ensuring that the generated set of AoD content (308) is aesthetically pleasing to the end user. Thus, the electronic device (201) retains the at least one variable AoD content that surpasses the calculated threshold after calculating the corresponding aesthetic scores. Accordingly, the final AoD content may meet functional requirements and provide a visually appealing experience for the user.

At operation S5, the electronic device (201) determines the at least one cross-device AoD content from the set of variable AoD contents (308) based on the AoD contextual information, wherein the at least one cross-device AoD content is consistent across multiple devices of the user of the electronic device (201), wherein the multiple devices are interconnected. The cross-device consistency block (307) displays the at least one determined cross-device AoD content on the AoD of the electronic device (201). Based on the AoD contextual information, the electronic device (201) determines any special event using the cross-device consistency block (307). For example, it might identify an event like the user's pet dog's birthday. The relevant source and content are then identified based on the determined special event in the electronic device (201), such as locating gallery images of the pet dog. Subsequently, the cross-device consistency block (307) generates the device-specific cross-device AoD content for all interconnected devices. Further, the cross-device consistency block (307) displays the at least one determined cross-device AoD content on the AoD of the electronic device (201). This is used for harmonizing the AoD content across all devices, providing a seamless user experience.

At operation S6, the electronic device displays the set of variable AoD contents (308), the at least one variable AoD content, or the at least one cross-device AoD content on the AoD of the electronic device (201). This operation may present the curated and contextually relevant AoD content to the user. The display of this content is may be relevant, contextually appropriate, aesthetically pleasing, and consistent across all of the user's devices.

The various actions, acts, blocks, operations, or the like in the method may be performed in the order presented, in a different order, or simultaneously. Further, in some embodiments, some of the actions, acts, blocks, operations, or the like may be modified, or actions, acts, blocks, operations, or the like may be added, without departing from the scope of the disclosure.

The foregoing descriptions explain various exemplary embodiments so that others can readily modify and or adapt the disclosure for various applications without departing from scope of the disclosure. It is also to be understood that the phrases or terms employed herein are for the purpose of description and not for limitation. Therefore, while various embodiments have been described herein, those skilled in the art will recognize that such embodiments may be practiced with modification within the scope of the disclosure.

What is claimed is:

1. A method for managing an Always-on-Display (AoD) of an electronic device, comprising:
receiving a candidate AoD content to be displayed on the electronic device and a AoD contextual information;
determining an AoD preferred pattern of a user of the electronic device based on the candidate AoD content and the AoD contextual information;
generating a set of variable AoD content corresponding to the candidate AoD content based on the AoD preferred pattern of the user and the AoD contextual information, wherein a plurality of AoD content of the set of variable AoD content is generated for a plurality of changes in the AoD contextual information; and
displaying the set of variable AoD content on the electronic device.

2. The method as claimed in claim 1, further comprising:
determining at least one variable AoD content from the set of variable AoD content based on a plurality of aesthetic parameters comprising at least one from among color schemes, font styles, and layout configurations, wherein the plurality of aesthetic parameters are dynamically adjusted based on ambient light conditions and user activity patterns; and
displaying the at least one variable AoD content on the AoD of the electronic device.

3. The method as claimed in claim 1, further comprising:
determining at least one cross-device AoD content from the set of variable AoD content based on the AoD contextual information, wherein the at least one cross-device AoD content is consistent across a plurality of devices of the user; and
displaying the at least one cross-device AoD content on the AoD of the electronic device.

4. The method as claimed in claim 1, wherein the receiving the candidate AoD content and the AoD contextual information comprises:
determining user context information based on a plurality of user parameters comprising at least one from among a behavior of the user, an emotional state of the user, a user preferences, an user personality, and a user defined AoD pattern;
determining device context information based on a plurality of device parameters comprising at least one from among a screen configuration, a battery information, temperature, location, time, and a user event; and
determining, by the electronic device, the AoD contextual information based on the user context information and the device context information, wherein the AoD contextual information indicates external context information of the electronic device and internal context information of the electronic device.

5. The method as claimed in claim 4, wherein the emotional state is determined based on at least one of one or more biometric sensor inputs or content of one or more user interactions.

6. The method as claimed in claim 4, further comprising:
determining an effect weightage for a plurality of AoD preferred patterns based on the AoD contextual information; and
storing the effect weightage for the plurality of AoD preferred patterns.

7. The method as claimed in claim 1, wherein the determining the AoD preferred pattern comprises:
segmenting the candidate AoD content into a plurality of segments;
generating modified candidate AoD content comprising one or more salient segments of the candidate AoD content by extracting the one or more salient segments from the plurality of segments based on the AoD contextual information;
determining one or more semantic features from the candidate AoD content and the modified candidate AoD content; and
determining the AoD preferred pattern based on the one or more semantic features and the AoD contextual information.

8. The method as claimed in claim 1, wherein the generating the set of variable AoD content and the AoD contextual information comprises:
determining at least one AoD content creation method from among a plurality of AoD content creation methods based on a type of the candidate AoD content and the AoD contextual information;
prioritizing the at least one AoD content creation method over remaining AoD content creation methods of the plurality of AoD content creation methods based on the type of the candidate AoD content and the AoD contextual information; and
generating the set of variable AoD content by applying the at least one prioritized AoD content creation method based on the AoD preferred pattern and the AoD contextual information.

9. The method as claimed in claim 8, wherein the plurality of AoD content creation methods comprise weighted binarization, adaptive points, a diffusion-based model, and adaptive brightness.

10. The method as claimed in claim 8, wherein the type of the candidate AoD content comprises one from among text, audio, an image, an animation, a video, a Graphics Interchange Format (GIF) file, and interactive content.

11. An electronic device for managing an Always-on-Display (AoD), comprising:
memory storing instructions;
a communication processor; and
an AoD controller communicatively coupled to the memory and the communication processor,
wherein the communication processor is configured to execute the instructions to cause the AoD controller to:
receive a candidate AoD content to be displayed on the electronic device and a AoD contextual information;
determine an AoD preferred pattern of a user of the electronic device based on the candidate AoD content and the AoD contextual information;
generate a set of variable AoD content corresponding to the candidate AoD content based on the AoD preferred pattern of the user and the AoD contextual information, wherein a plurality of AoD content of the set of variable AoD content is generated for a plurality of changes in the AoD contextual information; and
display the set of variable AoD content on the electronic device.

12. The electronic device as claimed in claim 11, wherein the communication processor is further configured to execute the instructions to cause the AoD controller to:
determine at least one variable AoD content from the set of variable AoD content based on a plurality of aesthetic parameters comprising at least one from among color schemes, font styles, and layout configurations, wherein the plurality of aesthetic parameters are dynamically adjusted based on ambient light conditions and user activity patterns; and
display the at least one variable AoD content on the AoD of the electronic device.

13. The electronic device as claimed in claim 11, wherein the communication processor is further configured to execute the instructions to cause the AoD controller to:
determine at least one cross-device AoD content from the set of variable AoD content based on the AoD contextual information, wherein the at least one cross-device AoD content is consistent across a plurality of devices of the user; and
display the at least one cross-device AoD content on the AoD of the electronic device.

14. The electronic device as claimed in claim 11, wherein the communication processor is configured to execute the instructions to cause the AoD to:
determine user context information based on a plurality of user parameters comprising at least one from among a behavior of the user, an emotional state of the user, a user preferences, an user personality, and a user defined AoD pattern;
determine device context information based on a plurality of device parameters comprising at least one from among a screen configuration, a battery information, temperature, location, time, and a user event of the electronic device; and
determine the AoD contextual information based on the user context information and the device context information, wherein the AoD contextual information indicates external context information of the electronic device and internal context information of the electronic device.

15. The electronic device as claimed in claim 14, wherein the emotional state is determined based on at least one of one or more biometric sensor inputs or content of one or more user interactions.

16. The electronic device as claimed in claim 11, wherein the communication processor is further configured to execute the instructions to cause the AoD controller to:
determine an effect weightage for a plurality of AoD preferred patterns based on the AoD contextual information; and
store the effect weightage for the plurality of AoD preferred patterns.

17. The electronic device as claimed in claim 11, wherein the communication processor is configured to execute the instructions to cause the AoD controller to:
segment the candidate AoD content into a plurality of segments;
generate modified candidate AoD content comprising one or more salient segments of the candidate AoD content by extracting the one or more salient segments from the plurality of segments based on the AoD contextual information;
determine one or more semantic features from the candidate AoD content and the modified candidate AoD content comprising the one or more salient segments of the candidate AoD content; and
determine the AoD preferred pattern based on the one or more semantic features and the AoD contextual information.

18. The electronic device as claimed in claim 11, wherein the communication processor is configured to execute the instructions to cause the AoD controller to:
determine at least one AoD content creation method from among a plurality of AoD content creation methods based on a type of the candidate AoD content and the AoD contextual information;
prioritize the at least one AoD content creation method over remaining AoD content creation methods of the plurality of AoD content creation methods based on the type of the candidate AoD content and the AoD contextual information; and
generate the set of variable AoD content by applying the at least one prioritized AoD content creation method based on the AoD preferred pattern and the AoD contextual information.

19. The electronic device as claimed in claim 18, wherein the plurality of AoD content creation methods comprise weighted binarization, adaptive points, a diffusion-based model, and adaptive brightness.

20. A non-transitory computer-readable recording medium having instructions recorded thereon, that, when executed by a communication processor communicatively coupled to an AoD controller of an Always-on-Display (AoD) of an electronic device, cause the AoD controller to:
receive a candidate AoD content to be displayed on the electronic device and a AoD contextual information;
determine an AoD preferred pattern of a user of the electronic device based on the candidate AoD content and the AoD contextual information;
generate a set of variable AoD content corresponding to the candidate AoD content based on the AoD preferred pattern of the user and the AoD contextual information, wherein a plurality of AoD content of the set of variable AoD content is generated for a plurality of changes in the AoD contextual information; and
display the set of variable AoD content on the electronic device.
